(19) United States
(12) Patent Application Publication
(10) Pub. No.: US 2008/0074967 A1
(43) Pub. Date: Mar. 27, 2008

(54) OPTICAL DISC SPARE AREA MANAGEMENT

(75) Inventors: Shih-hsin Chen, Jhubei City (TW); Ching-wen Hsueh, Luodong Township (TW); Ying-che Hung, San-Chung City (TW)

Correspondence Address: MADSON & AUSTIN, 15 WEST SOUTH TEMPLE, SUITE 900, SALT LAKE CITY, UT, 84101, US

(73) Assignee: Media Tek Inc., Hsin-Chu City (TW)

(21) Appl. No.: 11/534,442

(22) Filed: Sep. 22, 2006

(51) Int. Cl. G11B 20/10

(52) U.S. Cl. 369/47.1

(57) ABSTRACT

A spare area management method for a blu-ray rewritable disc and a disc drive implementing this method, as well as a novel blu-ray rewritable disc. The disc has a plurality of spare areas. According to the present invention, boundary of each spare area is found, and information thereabout such as a start address and size of each spare area are stored. Such boundary information is variable as the spare areas are used. In addition, the boundary information is written to the disc. Therefore, it is possible to more efficiently use the spare areas of the disc.

### TECHNICAL FIELD OF THE INVENTION

The present invention relates to an optical disc spare area management, more particularly, to a method for managing spare areas of a blur-ray rewritable disc and an optical disc drive implementing the method. Furthermore, the present invention relates to a novel blu-ray rewritable disc, of which spare areas are managed in an efficient manner.

### BACKGROUD OF THE INVENTION

An optical disc, such as a blu-ray disc, usually has spare areas defined for recording some backup information including replacement for a registered defect. A single layer disc has two spare areas at the inner-most and outer-most edges of the disc. These two spare areas are referred to as ISA (inner spare area) and OSA (outer spare area). Similarly, a double layer disc has four spare areas. There are spare areas ISA0 and OSA0 in layer 0 of the double layer disc, and spare areas ISA1 and OSA1 in layer 1 thereof, as shown in FIG. 1.

In a formatted blu-ray rewritable disc (simply referred to as “BD-RW” disc), a defect management structure (DMS) is recorded on the disc. The DMS includes a plurality of defect management area (DMA). FIG. 2 shows an example of a single layer disc. The disc has four DMAs (DMA1, DMA2, DMA3, DMA4) disposed in lead-in and lead-out regions, as shown in the drawing.

The DMS contains a disc definition structure (DDS) and a defect list (DFL). In the DDS, the format and status of the disc with relation to the defect management are specified. The DFL contains defect entries, each of which indicates the relationship between a defect and a replacement. Concerning spare areas, the DDS records total size of the spare areas. The size of ISA0 is recorded at Byte position 40 in Data Frame 0. The size of ISA1 is recorded at Byte position 44 in Data Frame 0. The size of OSA is recorded at Byte position 48 in Data Frame 0. The initial spare area size is decided during formatting or re-formatting the disc, and is fixed unless the disc is re-formatted again. In DFL, the header of the defect list records total number of available spare area entries, that is, the total number of the available spare clusters in the respective spare areas ISA0, OSA0, OSA1, ISA1. This number will be changed since the spare clusters may be consumed during writing the disc.

The DFL includes spare entry information (spare table) which contains Physical Sector Number (PSN) of each spare cluster. Taking a 50 G BD-RW disc as an example, after the disc is formatted, the ranges of respective spare areas are determined, and the spare entries are recorded in the spare table. FIG. 3 is a schematic illustration showing initial and used spare areas of a 50 G BD-RW The PSN codes of initial ISA0 spare entries are from 0x100000 to 0x11FFE0. The PSN codes of initial OSA0 spare entries are from 0xC27400 to 0xCA73E0. The PSN codes of initial OSA1 spare entries are from 0x1358C00 to 0x13D8BE0. The PSN codes of initial ISA1 spare entries are from 0x1E8000 to 0x1EFFFE0. The initial PSN codes of each spare area may be different according to different setting in the formatting process. In addition, the PSN range may also be different according different setting in formatting process. After the disc is used, some defects may be found, so that a corresponding number of spare clusters are used to allocate replacements. After a spare cluster is used, it is marked (e.g. a label code thereof is changed) and removed from the spare table. As shown, after being used, ISA0 spare entries become 0x110000 (start position changed) ˜0x11FFE0 (end position not changed), OSA0 spare entries become 0xC27400 (start position not changed) ˜0xCA0000 (end position changed), OSA1 spare entries become 0x1360000 (start position changed) ˜0x13D8BE0 (end position not changed), ISA1 spare entries become 0x1E80000 (start position not changed) ˜0x1EF0000 (end position changed). As shown, the total size of the available spare areas is reduced as compared with the initial size. The updated spare table is written back to the DFL of the disc, and the total size of the available spare areas is recorded in the DDS. However, no information about numbers of available spare clusters in the respective spare areas is established and written back to the disc.

As described above, only the total number of available spare clusters can be known. That is, only the sum of the remaining available sizes of the respective spare areas is known. Accordingly, it is not clear which one of the spare areas can be used when allocating a replacement, for example, results in inconvenience in allocation of the spare areas. When a defect is found, one of the spare clusters of the spare areas needs to be assigned to the defect for recording replacement thereof. For example, if one spare cluster of OSA0 should be assigned, it is necessary to search the whole spare table to find where the location of the first spare entry in OSA0 is. This is very inconvenient and reduces efficiency of spare area allocation. The present invention provides a solution to overcome this problem.

### SUMMERY OF THE INVENTION

An objective of the present invention is to provide a spare area management method for a blur-ray rewritable disc. By this method, it can be more efficient to use spare areas of the disc.

Another objective of the present invention is to provide a disc drive for a blur-ray rewritable disc. The disc drive can efficiently allocate spare areas of the disc.

A further objective of the present invention is to provided a novel blur-ray rewritable disc. Spare areas of such a disc can be allocated is a more efficient manner as compared to prior art.

In accordance with an aspect of the present invention, a spare area management method used in writing a blu-ray rewritable disc having a plurality of spare areas comprises steps of dynamically determining boundary of each spare area according to a spare table of the disc to distinguish the spare areas from each other; and storing the distinguished spare areas separately. The spare table records spare entries of each spare area, one spare entry being removed from the spare table after being used. In one embodiment, a start address and size of each spare area are dynamically stored in a memory during writing process. The finally stored start address and size of the spare area are written to the disc.

In accordance with another aspect of the present invention, a disc drive for a blu-ray rewritable disc having a plurality of spare areas comprises a spindle carrying the disc; a pick-up head accessing the disc to read the spare table from the disc; a servo driving the pick-up head; a memory storing the spare table read from the disc; and a control unit dynamically determining boundary of each spare area to distinguish the respective spare areas from each other based on the spare table and dynamically storing each distinguished spare area to the memory. The control unit finds a start address of each spare area and computes size of the spare area, then stores the start address and size of the spare area to the memory. Furthermore, the control unit writes the finally stored start address and size of the spare area to the disc.

In accordance with a further aspect of present invention, a novel blu-ray rewritable disc has a plurality of spare areas. The disc has a spare table stored therein. Information about boundary of each spare area is recorded on the disc. Specifically, a start address and size of each spare are is recorded on the disc. Such boundary information is variable as the spare areas are used.

### BRIEF DESCRIPTION OF THE DRAWINGS

FIG. 1 is a schematic illustration showing spare area arrangement of a double layer blu-ray rewritable disc;

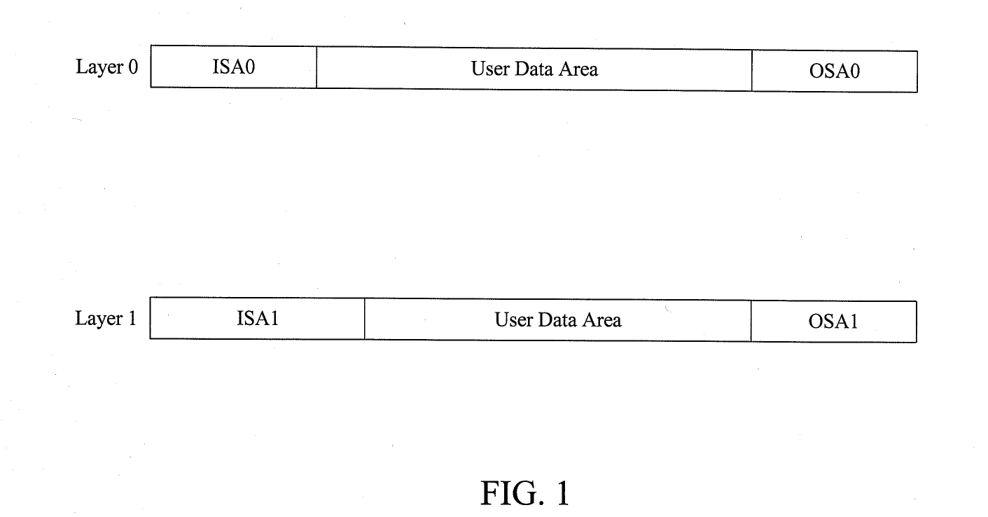

FIG. 2 is a schematic illustration showing defect management structure of a formatted blu-ray rewritable disc;

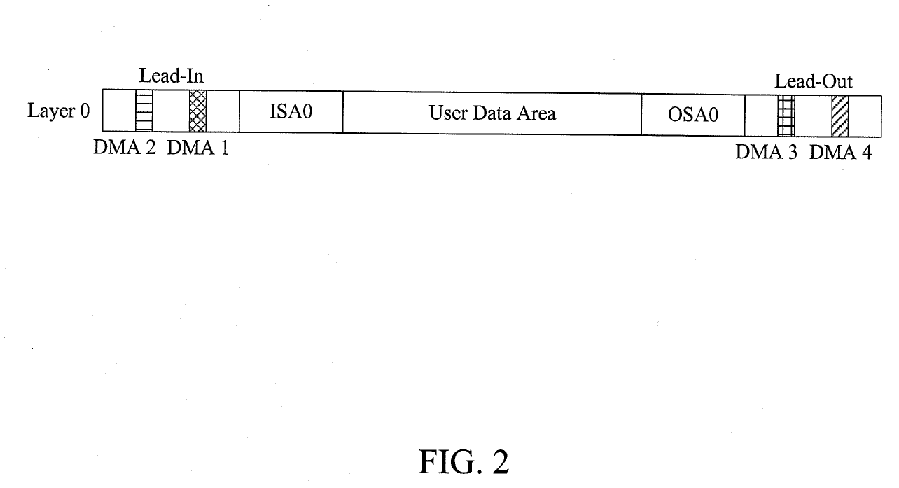

FIG. 3 is a schematic illustration showing a spare table for a 50 G blu-ray rewritable disc before and after some spare clusters are used;

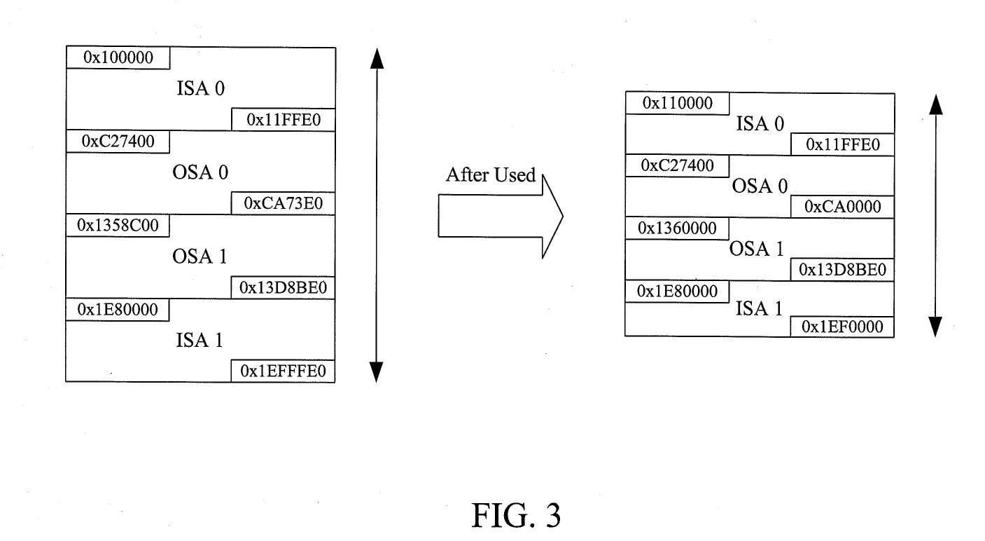

FIG. 4 is a block diagram schematically and roughly showing a disc drive in accordance with the present invention; and

FIG. 5 is a flow chart showing a method for computing spare area sizes in accordance with the present invention.

### DETAILED DESCRIPTION OF THE INVENTION

The present invention will be described in detail in conjunction with the appending drawings. In the following descriptions, a double layer (DL) blu-ray rewritable (BD-RW) disc is described as an example. The present invention is also applicable to a single layer (SL) BD-RW disc. The DL BD-RW has two layers, Layer 0 and Layer 1. The DL blu-ray disc has four spare areas, spare areas ISA0, OSA0 in Layer 0, and spare areas ISA1, OSA1 in Layer 1.

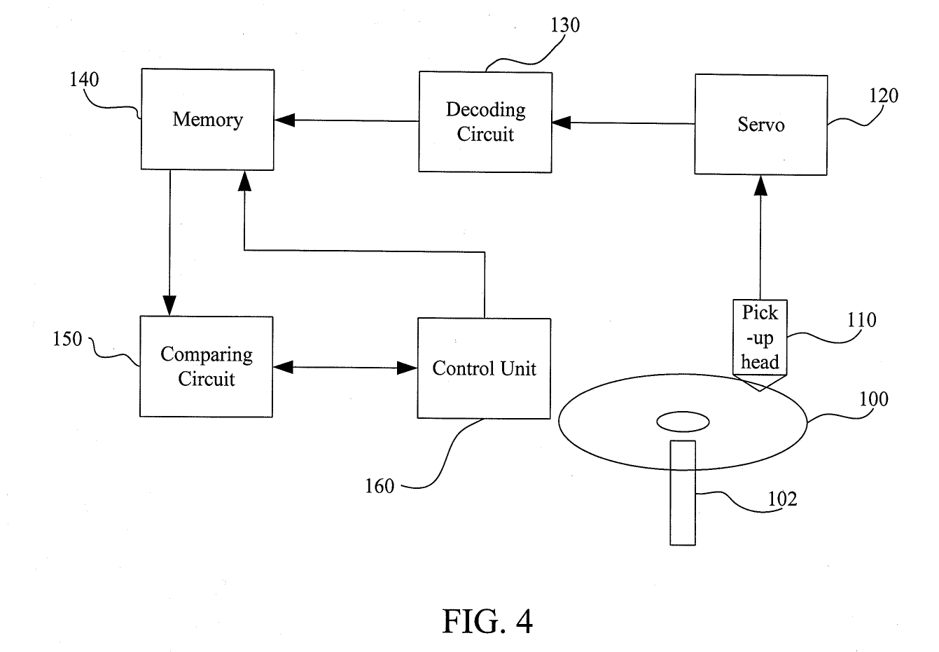

FIG. 4 schematically and roughly shows a disc drive in accordance with the present invention. When a formatted BD-RW disc 100 is put into the disc drive, the disc 100 is carried by a spindle 102. As described, the formatted BD-RW disc 100 has DDS and DFL. The disc drive fetches out a spare table from the disc 100 by means of a pick-up head (PUH) 110. As described, the spare table is contained in DFL stored in DMS of the disc 100. The disc drive stores the fetched spare table into a memory 140 as a memory spare table via a servo 120 and a decoding circuit 130. The servo 120 is used for driving the PUH 110, and the decoding circuit 130 is used for decoding data read from the disc 100, these two components are commonly known in this field, and therefore the detailed descriptions thereof are omitted herein for simplicity. The memory spare table is copied from the spare table in disc 100. The spare table in disc can be referred to as “disc spare table” for the sake of convenience of description. The memory 140 can be a volatile memory such as a DRAM.

A control unit 160 of the disc drive picks a physical address (e.g. PSN code) of the start position of each spare area as a physical start address and stores the start address into a specific location of the memory 140. The specific location can be referred to as a memory start address. The physical start address is the address of an available spare cluster for next use of each spare area. For example, for ISA0, the start address to be recorded is the address of the first spare cluster of the available entries. For OSA0, the start address to be recorded is the address of the last spare cluster of the available entries. This is because ISA0 is used from the least PSN, while OSA0 is used from the greatest PSN according to BD Specification. In addition, the disc drive further comprises a comparing circuit 150. The comparing circuit 150 is used to assist computing the size of each spare area, that is, the available entry number of each spare area. The size is also recorded in the memory 140.In the present embodiment, both the physical start address (e.g. PSN) and the spare area size (e.g. available entry number) for each spare area are recorded in the memory 140. However, in practice, it is possible to only record either the start PSN code or the available entry number into the memory 140. Preferably, such information is recorded into a vendor-specific field defined in a disc specification, for example, a field in a drive-specific area defined in BD Specification. According to BD Specification, some fields of the drive-specific area of a BD are freely usable by a disc drive,

During writing the disc, the physical start address of each spare area may change, and the size of the spare area may vary since the spare clusters of the spare area may be used. The different physical start address is stored in the memory start address the same mentioned above. For example, no matter what the physical start address of spare area ISA0 becomes, the physical start address is always stored in the same specific memory start address. That is, the physical start address stored in the location indicated by the specific memory start address is updated whenever the physical start address changes. However, the latest updated physical start address of the spare area ISA0 can always be obtained from this specific memory start address. By obtaining the start address and the size of each spare area, the boundary of each spare area can be known. Thus, it is possible to more efficiently utilize the spare areas of the disc 100. When the disc 100 is exited from the disc drive, the final physical start address and size of each spare area are written back to a specific location of the disc 100. For example, the new start address and size of each spare area can be recorded in the spare table in the memory 140, and the updated spare table is then written back to cover the old spare table of the disc 100. When the disc is used in the future, the recorded start addresses and sizes of the respective spare areas can be fetched as reference.

Whenever the spare entry is changed (e.g. the start address is different, the size of the spare area is reduced), the change is marked in the spare table stored in the memory 140. Alternatively, the changed data can be stored in another location of the memory 140.

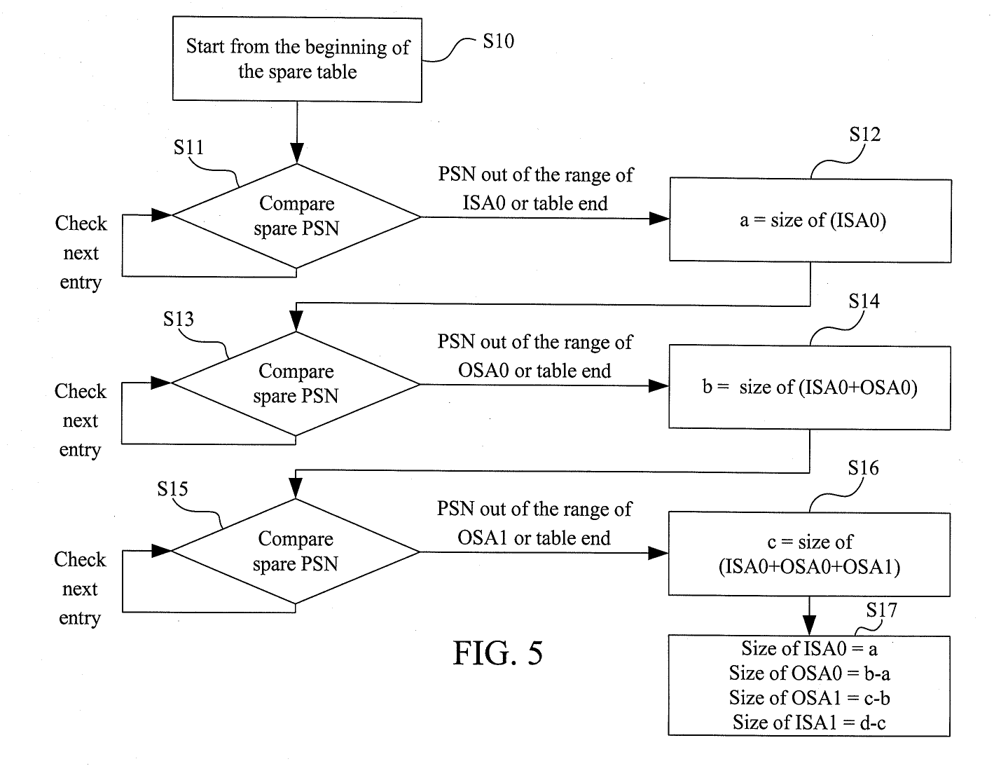

FIG. 5 is a flow chart showing an embodiment of a method for computing sizes of the respective spare areas in accordance with the present invention. As known, PSN codes for the spare clusters (spare entries) are very different from spare area to spare area, so it is easy to distinguish the respective spare areas by checking the PSN codes. This method for computing the spare area sizes utilizes such a feature. In addition, for a DL BD-RW disc 100, the spare entries of the four spare areas are listed in the spare table of a sequence of ISA0, OSA0, OSA1 and ISA1. The computing process is started from the beginning of the spare table in step S10. The comparing circuit 150 compares PSN code of the first spare entry. That is, the PSN code of the first spare cluster is compared with a reference. The comparing circuit 150 checks if the PSN is out of a range of ISA0 or the end of the spare table is reached (step SI 1). The range can be determined according to the information in the spare table. If the PSN is still within the range, and the table end has not been reached, the comparing circuit 150 will check the next spare entry. Otherwise, if the PSN is out of the range of ISA0, or the table end is reached, then the size of ISA0 “a” can be obtained (step S12). Then the process goes to step S13. In S13, the comparing circuit 150 checks if the PSN is out of a range of OSA0 or the end of the spare table is reached. If the PSN is still within the range, and the table end has not been reached, the comparing circuit 150 will check the next spare entry. Otherwise, if the PSN is out of the range of OSA0, or the table end is reached, then the total size of ISA0+OSA0 “b” can be obtained (step S14). Then the process goes to step S15. In S15, the comparing circuit 150 checks if the PSN is out of a range of OSA1 or the end of the spare table is reached. If the PSN is still within the range, and the table end has not been reached, the comparing circuit 150 will check the next spare entry. Otherwise, if the PSN is out of the range of OSA1, or the table end is reached, then the total size of ISA0+OSA0+OSA1 “c” can be obtained (step S14). Finally, the control unit computes the sizes of the respective spare areas as:

ISA0 size=a (1)

OSA0 size=b-a (2)

OSA1 size=c-b (3)

ISA1 size=d-c (4)

wherein d is the total available size of all spare area, which is recoded in defect list header. It is noted that the comparing circuit 150 can be an individual block or integrated into the control unit 160 in hardware, firmware or software form.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A spare area management method used in writing a rewritable disc, the disc having a plurality of spare areas and a spare table having spare entries of each spare area, one spare entry being removed from the spare table after being used, the method comprising steps of:
determining boundary of each spare area according to the spare table to distinguish the spare areas from each other; and
storing boundary information of the distinguished spare areas.

2. The method of claim 1, wherein the boundary information comprises at least one of a start address of each spare area and size information of each spare area.

3. The method of claim 2, wherein the start address is a physical address of an available entry for next use of each spare area.

4. The method of claim 2, wherein the size information is a number of available spare entries of each spare area.

5. The method of claim 2, wherein the size information of one spare area is obtained by checking if one spare entry is out of a range of said one spare area and counting the spare entries not been used within the range of said one spare area.

6. The method of claim 1, wherein the boundary information of the distinguished spare areas are separately stored in a memory.

7. The method of claim 6, wherein the start address is stored in a specific location of the memory, and the specific location is recorded.

8. The method of claim 1, wherein the boundary information of the distinguished spare areas are separately recorded to the disc.

9. The method of claim 1, wherein the storing step comprising dynamically storing the boundary information of each distinguished spare area in a memory and writing the boundary information the distinguished spare area latest stored in the memory to the disc.

10. A disc drive for writing a rewritable disc, the disc having a plurality of spare areas and a spare table having spare entries of each spare area, one spare entry being removed from the spare table after being used, the disc drive comprising:
a pick-up head for accessing the rewritable disc;
a memory for storing the spare table from the disc; and
a control unit coupled to the pick-up head and the memory for dynamically determining boundary of each spare area to distinguish the respective spare areas from each other based on the spare table and storing boundary information of each distinguished spare area to the memory.

11. The disc drive of claim 10, wherein the control unit further instructs the pick-up head to write the boundary information of each spare area latest stored in the memory to the disc.

12. The disc drive of claim 10, wherein the control unit finds a start address of each spare area and stores the start address of each spare area to the memory.

13. The disc drive of claim 12, wherein the start address is a physical address of an available entry for next use of each distinguished spare area

14. The disc drive of claim 12, wherein the start address is stored in a specific location of the memory, and the specific location is recorded.

15. The disc drive of claim 14, wherein the latest stored start address is read from the specific location of the memory and written to the disc.

16. The disc drive of claim 10, wherein the control unit computes the size of each spare area and stores the size information of each spare area to the memory.

17. The disc drive of claim 16, wherein the size information is a number of available spare entries of each spare area.

18. The disc drive of claim 16, further comprising a comparing circuit comparing PSN codes of the spare entries of each spare area, and the compared result is used to assist computing the size of the spare area.

19. The disc drive of claim 18, wherein the comparing circuit checks if one spare entry is out of a range of the spare area.

20. A blu-ray rewritable disc having a plurality of spare areas and a spare table recording spare entries of each spare area, one spare entry being removed from the spare table after being used, boundary information of each spare area being dynamically recorded to the disc.

21. The disc of claim 20, wherein the boundary information comprises a start address of each spare area.

22. The disc of claim 21, wherein the start address is a physical address of an available entry for next use of each spare area.

23. The disc of claim 20, wherein the boundary information comprises size information of each spare area.

24. The disc of claim 23, wherein the size information is a number of available spare entries of each spare area.
